(19) United States
(12) Patent Application Publication
(10) Pub. No.: US 2013/0152588 A1
(43) Pub. Date: Jun. 20, 2013

(54) METHOD AND APPARATUS FOR CONTROLLING OUTPUT OF PRESSURE SETTING SIGNAL TO AUTOMATICALLY CONTROL STEAM BYPASS CONTROL SYSTEM, AND METHOD AND APPARATUS FOR AUTOMATICALLY CONTROLLING STEAM BYPASS CONTROL SYSTEM BY USING THE PRESSURE SETTING SIGNAL

(71) Applicants: Myung Jun SONG, Daejeon (KR); See Chae JEONG, Gyeonggi-do (KR); Chan Eok PARK, Daejeon (KR); Ju Han LEE, Daejeon (KR); Jong Joo SOHN, Daejeon (KR)

(72) Inventors: Myung Jun SONG, Daejeon (KR); See Chae JEONG, Gyeonggi-do (KR); Chan Eok PARK, Daejeon (KR); Ju Han LEE, Daejeon (KR); Jong Joo SOHN, Daejeon (KR)

(73) Assignee: KEPCO ENGINEERING & CONSTRUCTION COMPANY, Gyeonggi-Do (KR)

(21) Appl. No.: 13/478,604

(22) Filed: May 23, 2012

(30) Foreign Application Priority Data
Dec. 15, 2011 (KR) 10-2011-0135771

(51) Int. Cl. G21D 5/00; F01K 13/02; G21D 3/08

(52) U.S. Cl. 60/646; 60/661; 60/644.1

(57) ABSTRACT

An apparatus for controlling an output of a pressure setting signal to automatically control a steam bypass control system includes a pressure setting signal output unit for outputting a pressure setting signal according to a cold leg temperature of a reactor coolant; a first logic value output unit for outputting a first logic value that is changed according to reactor power; a second logic value output unit for outputting a second logic value that is changed according to a temperature difference between an average temperature of the reactor coolant and a reference temperature; a NAND gate circuit unit for outputting an inverse logic value according to the first and second logic values; and a first output control unit for controlling whether to output the pressure setting signal according to the inverse logic value of the NAND gate circuit unit.

### CROSS-REFERENCE TO RELATED PATENT APPLICATION

This application claims the benefit of Korean Patent Application No. 10-2011-0135771, filed on Dec. 15, 2011, in the Korean Intellectual Property Office, the disclosure of which is incorporated herein in its entirety by reference.

### BACKGROUND OF THE INVENTION

1. Field of the Invention

The present invention relates to automatic control of a steam bypass control system during high-power synchronization and de-synchronization so as to control the pressure of a steam generator of a nuclear power plant, and more particularly, to optimum automatic control of a steam bypass control system during high-power synchronization and de-synchronization without manual control of an operator by changing a setpoint of the steam bypass control system by using a cold leg temperature of a reactor coolant as an input variable.

2. Description of the Related Art

A control logic of a conventional steam bypass control system for controlling the pressure of a steam generator increases a cold leg temperature of a reactor coolant during high-power synchronization and de-synchronization, and thus, the cold leg temperature exceeds an operating limit defined in plant technical specifications. Accordingly, the conventional steam bypass control system may not operate in a remote auto mode during high-power synchronization and de-synchronization, and may cause difficulties in maintaining the cold leg temperature of the reactor coolant within the operating limit defined in the plant technical specifications in a local auto mode by manual control of an operator.

FIG. 1 is a block diagram of a conventional steam bypass control system of a nuclear power plant. The conventional steam bypass control system controls opening/closing of turbine bypass valves for emitting excess steam of a power plant into a condenser or air. Reference numeral 1 indicates a main steam header pressure signal, reference numeral 2 indicates a steam flow signal, reference numeral 3 indicates a pressurizer pressure signal, reference numeral 4 indicates a lag unit, reference numeral 5 indicates a steam flow compensation signal, reference numeral 6 indicates a main steam header pressure setpoint program, reference numeral 7 indicates a pressurizer pressure bias program, reference numeral 8 indicates a main steam header pressure setpoint signal, reference numeral 9 indicates a pressurizer pressure bias signal, reference numeral 10 indicates a steam bypass control system setpoint signal, reference numeral 11 indicates a steam bypass control system error signal, and reference numeral 12 indicates a proportional-integral controller.

The conventional steam bypass control system is designed to increase utilization of a power plant by removing excess heat energy of a nuclear steam supply system due to load rejection of a turbine by using a maximum bypass capacity of the turbine bypass valves. This is enabled by adjusting by selectively using turbine bypass valves and adjusting the amount of emitted steam. As such, an unnecessary shutdown of a reactor may be prevented and opening of pressurizer or main steam safety valves may be prevented too. Furthermore, if an event for rapidly increasing the pressure of a steam generator, e.g., load rejection, occurs, in order to prevent shutdown of a reactor by applying a quick open mode according to the size of load rejection, a reactor power cutback system is actuated and turbine bypass valves are open in groups.

In the conventional steam bypass control system, the steam flow signal 2 is transmitted to the lag unit 4 and the main steam header pressure setpoint program 6, and the pressurizer pressure signal 3 is transmitted to the pressurizer pressure bias program 7, thereby outputting the pressurizer pressure bias signal 9. The steam bypass control system setpoint signal 10 obtained by summing the main steam header pressure setpoint signal 8 and the pressurizer pressure bias signal 9 is compared to the measured main steam header pressure signal 1, and a deviation signal between the steam bypass control system setpoint signal 10 and the main steam header pressure signal 1, i.e., the steam bypass control system error signal 11, is output to the proportional-integral controller 12. A controller signal or a manual signal generated by an operator is transmitted to an electrical/air transformer on turbine bypass valves. The transformer transforms an electrical signal into an air signal and transmits the air signal to an air-driven turbine bypass valve via a first solenoid valve. In a quick open mode, the pressurizer pressure signal 3 is compared to the steam flow signal 2 and a deviation signal between them is transmitted to a change detector. If an output of the change detector exceeds a threshold value, a quick open signal is generated. The quick open signal excites a solenoid and applies full-pressure air to block the adjusted air signal and rapidly open a valve.

An automatic control mode of a steam bypass control system includes a remote auto mode and a local auto mode. The remote auto mode is an automatic control mode using a setpoint programmed by the steam bypass control system and is used in a general system operation, and a quick open mode is executed only in the remote auto mode. The local auto mode is a control mode mostly used during synchronization and de-synchronization, and is an automatic control mode used to maintain the temperature of a reactor coolant by adjusting a setpoint by an operator.

Synchronization is generally performed at 10 to 20% of reactor power and de-synchronization for an overspeed test of a turbine is performed after synchronization by ramping turbine power below 100 MWe (electrical power corresponding to about 10% of the turbine power). However, since synchronization and de-synchronization are currently performed at 25 to 30% of reactor power to increase availability of nuclear power plants, due to an imbalance in power between primary and secondary sides during de-synchronization for ramping turbine power below 100 MWe, a cold leg temperature of a reactor coolant is increased to exceed an operating limit defined in plant technical specifications in many cases.

Since a logic for changing a setpoint according to a change in temperature of a reactor coolant is not included, the steam bypass control system has to operate in a local auto mode and an operator has to manually change the setpoint during synchronization and de-synchronization. However, during high-power synchronization and de-synchronization, since a deviation in power between primary and secondary sides is large, if the steam bypass control system operates in a local auto mode, the temperature of a reactor coolant may not be easily controlled which causes difficulties in controlling the steam bypass control system. Therefore, when a transient event such as load rejection occurs during high-power synchronization and de-synchronization, an automatic control logic is required in order not to cause a transient state of a power plant while maintaining the steam bypass control system in a remote auto mode to be switched to a quick open mode, and not to exceed an operating limit defined in plant technical specifications while ramping the turbine power below 100 MWe.

### SUMMARY OF THE INVENTION

The present invention provides a method and apparatus for controlling an output of a pressure setting signal to automatically control a steam bypass control system, and a method and apparatus for automatically controlling a steam bypass control system by using the pressure setting signal, in which a bias program is used to decrease a pressure setpoint of a steam bypass control system during high-power synchronization and de-synchronization if a cold leg temperature of a reactor coolant, i.e., an input signal of an automatic control logic, is increased close to an operating limit defined in plant technical specifications, thereby achieving optimum automatic control of the steam bypass control system.

According to an aspect of the present invention, there is provided an apparatus for controlling an output of a pressure setting signal to automatically control a steam bypass control system, the apparatus including a pressure setting signal output unit for outputting a pressure setting signal according to a cold leg temperature of a reactor coolant; a first logic value output unit for outputting a first logic value that is changed according to reactor power; a second logic value output unit for outputting a second logic value that is changed according to a temperature difference between an average temperature of the reactor coolant and a reference temperature; a NAND gate circuit unit for outputting an inverse logic value according to the first and second logic values output from the first and second logic value output units; and a first output control unit for controlling whether to output the pressure setting signal to a turbine bypass valve control unit for emitting excess steam of a reactor, according to the inverse logic value of the NAND gate circuit unit.

The pressure setting signal output unit may output the pressure setting signal for decreasing a pressure setpoint by a certain value if the cold leg temperature of the reactor coolant is increased above a certain temperature.

The first logic value output unit may change and output the first logic value if the reactor power is increased above a first reference ratio or is decreased below a second reference ratio.

A deadband in which the first logic value is not changed may exist between the first and second reference ratios.

The second logic value output unit may change and output the second logic value if the temperature difference between the average temperature of the reactor coolant and the reference temperature is increased above a first reference temperature or is decreased below a second reference temperature.

A deadband in which the second logic value is not changed may exist between the first and second reference temperatures.

The first output control unit may control to output the pressure setting signal to the turbine bypass valve control unit if the reactor power is less than a certain ratio and the temperature difference between the average temperature of the reactor coolant and the reference temperature is greater than a certain temperature.

The apparatus may further include a second output control unit for controlling whether to output the pressure setting signal to the turbine bypass valve control unit, according to a control signal of an operator.

According to another aspect of the present invention, there is provided an apparatus for automatically controlling a steam bypass control system, the apparatus including a pressure setting signal output unit for outputting a pressure setting signal according to a cold leg temperature of a reactor coolant; a first logic value output unit for outputting a first logic value that is changed according to reactor power; a second logic value output unit for outputting a second logic value that is changed according to a temperature difference between an average temperature of the reactor coolant and a reference temperature; a NAND gate circuit unit for outputting an inverse logic value according to the first and second logic values output from the first and second logic value output units; a first output control unit for controlling whether to output the pressure setting signal according to the inverse logic value of the NAND gate circuit unit; and a turbine bypass valve control unit for controlling whether to open or close a turbine bypass valve by using a deviation signal calculated between a measured main steam header pressure signal and a summed pressure signal obtained by summing a main steam header pressure setting signal according to a steam flow and a pressurizer pressure bias signal according to a pressurizer pressure with the pressure setting signal.

According to another aspect of the present invention, there is provided a method of controlling an output of a pressure setting signal to automatically control a steam bypass control system, the method including individually outputting a first logic value that is changed according to an increase or decrease in reactor power and a second logic value that is changed according to a temperature difference between an average temperature of a reactor coolant and a reference temperature; outputting an inverse logic value according to the first and second logic values; and outputting a pressure setting signal according to a cold leg temperature of the reactor coolant to a turbine bypass valve control unit for emitting excess steam of a reactor, according to the inverse logic value.

The outputting of the first logic value may include changing and outputting the first logic value if the reactor power is increased above a first reference ratio or is decreased below a second reference ratio.

The outputting of the second logic value may include changing and outputting the second logic value if the temperature difference between the average temperature of the reactor coolant and the reference temperature is increased above a first reference temperature or is decreased below a second reference temperature.

The outputting of the pressure setting signal to the turbine bypass valve control unit may include outputting the pressure setting signal to the turbine bypass valve control unit if the reactor power is less than a certain ratio and if the temperature difference between the average temperature of the reactor coolant and the reference temperature is greater than a certain temperature.

According to another aspect of the present invention, there is provided a method of automatically controlling a steam bypass control system, the method including individually outputting a first logic value that is changed according to an increase or decrease in reactor power and a second logic value that is changed according to a temperature difference between an average temperature of a reactor coolant and a reference temperature; outputting an inverse logic value according to the first and second logic values; outputting a pressure setting signal according to a cold leg temperature of the reactor coolant to a turbine bypass valve control unit for emitting excess steam from a reactor, according to the inverse logic value; and controlling whether to open or close a turbine bypass valve by using a deviation signal calculated between a measured main steam header pressure signal and a summed pressure signal obtained by summing a main steam header pressure setting signal according to a steam flow, a pressurizer pressure bias signal according to a pressurizer pressure, and the pressure setting signal.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a conventional steam bypass control system of a nuclear power plant;

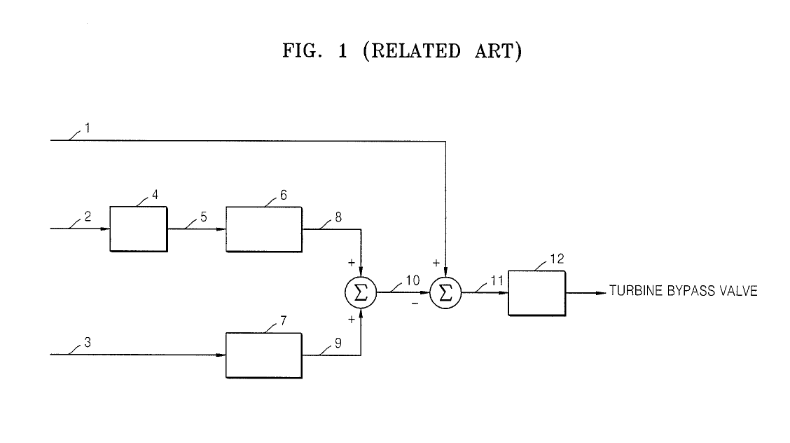

FIG. 2 is a block diagram of an apparatus for controlling an output of a pressure setting signal to automatically control a steam bypass control system, according to an embodiment of the present invention;

FIG. 3 is a graph showing an example of a pressure setpoint set by a pressure setpoint decreasing bias program stored in a pressure setting signal output unit illustrated in FIG. 2;

FIG. 4 is a block diagram of an apparatus for automatically controlling a steam bypass control system, according to an embodiment of the present invention;

FIG. 5 is a flowchart of a method of controlling an output of a pressure setting signal to automatically control a steam bypass control system, according to an embodiment of the present invention; and

FIG. 6 is a flowchart of a method of automatically controlling a steam bypass control system, according to an embodiment of the present invention.

### DETAILED DESCRIPTION OF THE INVENTION

Hereinafter, the present invention will be described in detail by explaining embodiments of the invention with reference to the attached drawings. As used herein, the term “and/or” includes any and all combinations of one or more of the associated listed items.

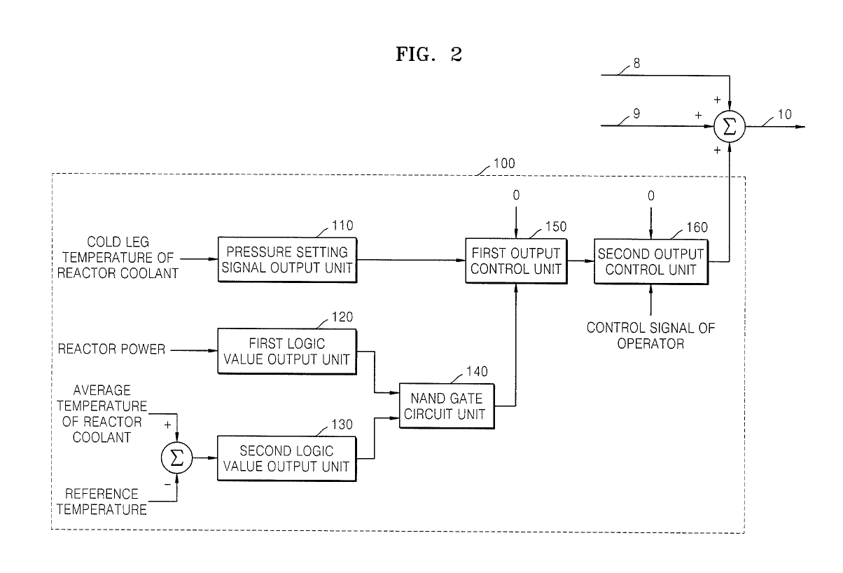

FIG. 2 is a block diagram of an apparatus 100 for controlling an output of a pressure setting signal to automatically control a steam bypass control system, according to an embodiment of the present invention. The output control apparatus 100 includes a pressure setting signal output unit 110, a first logic value output unit 120, a second logic value output unit 130, a NAND gate circuit unit 140, a first output control unit 150, and a second output control unit 160.

The pressure setting signal output unit 110 stores a pressure setting signal according to a cold leg temperature of a reactor coolant and, if data regarding the cold leg temperature of the reactor coolant is input, outputs the pressure setting signal corresponding to the data to the first output control unit 150. The cold leg temperature of the reactor coolant is a temperature of a coolant that flows into a reactor.

The pressure setting signal output unit 110 stores a bias program used to output the pressure setting signal for decreasing a pressure setpoint by a certain value if the cold leg temperature of the reactor coolant is increased above a certain temperature. In particular, as the pressure setpoint, a bias value within a range that does not exceed an operating limit defined in plant technical specifications is set.

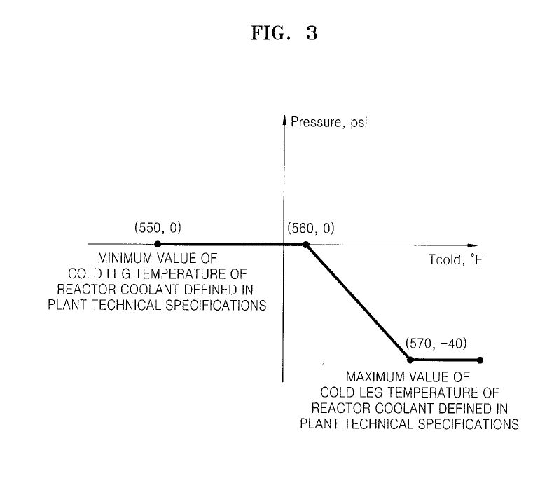

FIG. 3 is a graph showing an example of a pressure setpoint set by a pressure setpoint decreasing bias program stored in the pressure setting signal output unit 110 illustrated in FIG. 2. As illustrated in FIG. 3, the pressure setpoint when the cold leg temperature of the reactor coolant is 550° F. corresponding to a minimum value is 0 pound per square (psi), and the pressure setpoint when the cold leg temperature of the reactor coolant is 570° F. corresponding to a maximum value (i.e., an operating limit defined in plant technical specifications) is −40 psi. Accordingly, if data regarding the measured cold leg temperature of the reactor coolant is input, the pressure setting signal output unit 110 outputs a pressure setpoint corresponding to the cold leg temperature of the reactor coolant.

The first logic value output unit 120 calculates a first logic value that is changed according to an increase or decrease in reactor power, and outputs the calculated first logic value to the NAND gate circuit unit 140. The first logic value output unit 120 changes and outputs the first logic value if the reactor power is increased above a first reference ratio and/or is decreased below a second reference ratio. For this, the first logic value output unit 120 includes a reactor power recognition program and outputs the first logic value according to the reactor power by using the reactor power recognition program. For example, when the reactor power is synchronization, if the reactor power is increased above 30% corresponding to the first reference ratio, the first logic value output unit 120 changes the first logic value from “1” to “0” and outputs the changed first logic value of “0” to the NAND gate circuit unit 140. Also, when the reactor power is de-synchronization, if the reactor power is decreased below 28% corresponding to the second reference ratio, the first logic value output unit 120 changes the first logic value from “0” to “1” and outputs the changed first logic value of “1” to the NAND gate circuit unit 140.

Meanwhile, a deadband in which the first logic value is not changed exists between the first and second reference ratios. For example, if the first reference ratio when the reactor power is increased is 30% and the second reference ratio when the reactor power is decreased is 28%, although the reactor power is increased from below 28% and reaches 29% between 28% and 30%, the first logic value is not changed. On the other hand, although the reactor power is decreased from above 30% and reaches 29% between 28% and 30%, the first logic value is not changed. The period corresponding to 2% between 30%, i.e., the first reference ratio, and 28%, i.e., the second reference ratio, is referred to as a deadband regarding the reactor power.

The second logic value output unit 130 calculates a second logic value that is changed according to a temperature difference between an average temperature of the reactor coolant and a reference temperature, and outputs the calculated second logic value to the NAND gate circuit unit 140. The reference temperature has a value obtained by converting turbine power into a temperature. The second logic value output unit 130 changes and outputs the second logic value if the temperature difference between the average temperature of the reactor coolant and the reference temperature is increased above a first reference temperature and/or is decreased below a second reference temperature. For this, the second logic value output unit 130 includes a temperature difference recognition program and outputs the second logic value according to the temperature difference between the average temperature of the reactor coolant and the reference temperature by using the temperature difference recognition program.

For example, if the temperature difference between the average temperature of the reactor coolant and the reference temperature is above 5° F. corresponding to the first reference temperature, the second logic value output unit 130 changes the second logic value from “0” to “1” and outputs the changed second logic value of “1” to the NAND gate circuit unit 140. Also, if the temperature difference is below 3° F. corresponding to the second reference temperature, the second logic value output unit 130 changes the second logic value from “1” to “0” and outputs the changed second logic value of “0” to the NAND gate circuit unit 140.

Meanwhile, a deadband in which the second logic value is not changed exists between the first and second reference temperatures. For example, if the first reference temperature when the temperature difference between the average temperature of the reactor coolant and the reference temperature is increased is 5° F. and the second reference temperature when the temperature difference between the average temperature of the reactor coolant and the reference temperature is decreased is 3° F., although the temperature difference is increased from below 3° F. and reaches 4° F. between 3° F. and 5° F., the second logic value is not changed. On the other hand, although the temperature difference is decreased from above 5° F. and reaches 4° F. between 3° F. and 5° F., the second logic value is not changed. The period corresponding to 2° F. between 5° F., i.e., the first reference temperature, and 3° F., i.e., the second reference temperature, is referred to as a deadband regarding the temperature difference between the average temperature of the reactor coolant and the reference temperature.

The NAND gate circuit unit 140 calculates the inverse logic value according to the first and second logic values output from the first and second logic value output units 120 and 130, and outputs the calculated inverse logic value to the first output control unit 150. A logic calculation result of the NAND gate circuit unit 140 is as shown in Table 1.

TABLE 1

| | | Calculation Result of |
|---|---|---|
| First Logic Value | Second Logic Value | NAND Gate |
| 0 | 0 | 1 |
| 0 | 1 | 1 |
| 1 | 0 | 1 |
| 1 | 1 | 0 |

The first output control unit 150 controls whether to output the pressure setting signal provided from the pressure setting signal output unit 110 to a turbine bypass valve control unit for emitting excess steam of a reactor, according to the inverse logic value of the NAND gate circuit unit 140.

The first output control unit 150 controls to output the pressure setting signal to the turbine bypass valve control unit if the reactor power is less than a certain ratio and if the temperature difference between the average temperature of the reactor coolant and the reference temperature is greater than a certain temperature. For example, if both the first and second logic values of the first and second logic value output units 120 and 130 are “1”, the NAND gate circuit unit 140 outputs the inverse logic value of “0” to the first output control unit 150. If the inverse logic value of “0 ” is received from the NAND gate circuit unit 140, the first output control unit 150 controls to output the pressure setting signal that is an output signal of the pressure setting signal output unit 110. However, if at least one of the first and second logic values of the first and second logic value output units 120 and 130 is “0”, the NAND gate circuit unit 140 outputs the inverse logic value of “1” to the first output control unit 150. If the inverse logic value of “1” is received from the NAND gate circuit unit 140, the first output control unit 150 controls to output a value of “0” instead of the output signal of the pressure setting signal output unit 110. Accordingly, since “1” is output if the temperature difference between the reference temperature that is changed while ramping the turbine power (a variable representing the turbine power) and the average temperature of the reactor coolant is increased above a certain temperature, and “1” is output if the reactor power is less than a certain ratio, the pressure setting signal is output to the turbine bypass valve control unit only if the reactor power is less than the certain ratio and the temperature difference between the average temperature of the reactor coolant and the reference temperature is greater than the certain temperature.

Meanwhile, the second output control unit 160 controls whether to output the pressure setting signal to the turbine bypass valve control unit according to a control signal of an operator. Although the pressure setting signal is provided from the first output control unit 150, the pressure setting signal or a signal of “0” is output to the turbine bypass valve control unit according to the control signal of the operator. However, the second output control unit 160 is not essential and may be omitted according to circumstances.

Each of the above-described elements will now be described with examples of different cases. For this, it is assumed that the setpoint set by the pressure setpoint decreasing bias program after the cold leg temperature is measured is as illustrated in FIG. 3. Also, it is assumed that the first reference ratio when the reactor power is increased (synchronization) is 30% and the second reference ratio when the reactor power is decreased (de-synchronization) is 28%. In this case, a period of 2% exists as the deadband regarding the reactor power. Furthermore, the first reference temperature when the temperature difference between the average temperature of the reactor coolant and the reference temperature is increased is 5° F. and the second reference temperature when the temperature difference is decreased is 3° F. In this case, a period of 2° F. exists as the deadband regarding the temperature difference of the reactor coolant. In a first exemplary case, if the cold leg temperature of the reactor coolant is 570° F., the reactor power is increased to cause synchronization at a ratio of 29%, and the temperature difference between the average temperature of the reactor coolant and the reference temperature is 6° F., the pressure setting signal output unit 110 outputs the pressure setting signal of −40 psi by using the pressure setpoint decreasing bias program, the first logic value output unit 120 outputs the first logic value of “1” by using the reactor power recognition program after the cold leg temperature is measured, and the second logic value output unit 130 outputs the second logic value of “1” by using the temperature difference recognition program. After that, the NAND gate circuit unit 140 provides the inverse logic value of “0” to the first output control unit 150. As such, the first output control unit 150 controls to output the pressure setting signal of −40 psi to the turbine bypass valve control unit. As such, a current setpoint of the steam bypass control system is decreased by −40 psi corresponding to the pressure setting signal and is compared to an actual steam header pressure, thereby automatically opening a turbine bypass valve. In a second exemplary case, if the cold leg temperature of the reactor coolant is 570° F., the reactor power is decreased to cause de-synchronization at a ratio of 30%, and the temperature difference between the average temperature of the reactor coolant and the reference temperature is 6° F., the pressure setting signal output unit 110 outputs the pressure setting signal of −40 psi by using the pressure setpoint decreasing bias program, the first logic value output unit 120 outputs the first logic value of “0” by using the reactor power recognition program after the cold leg temperature is measured, and the second logic value output unit 130 outputs the second logic value of “1” by using the temperature difference recognition program. After that, the NAND gate circuit unit 140 provides the inverse logic value of “1” to the first output control unit 150. As such, the first output control unit 150 controls to output a value of 0 psi instead of the pressure setting signal to the turbine bypass valve control unit. Therefore, although the pressure setting signal output unit 110 outputs the pressure setting signal of −40 psi, the first output control unit 150 blocks the pressure setting signal and thus a current setpoint of a steam bypass control valve is not changed.

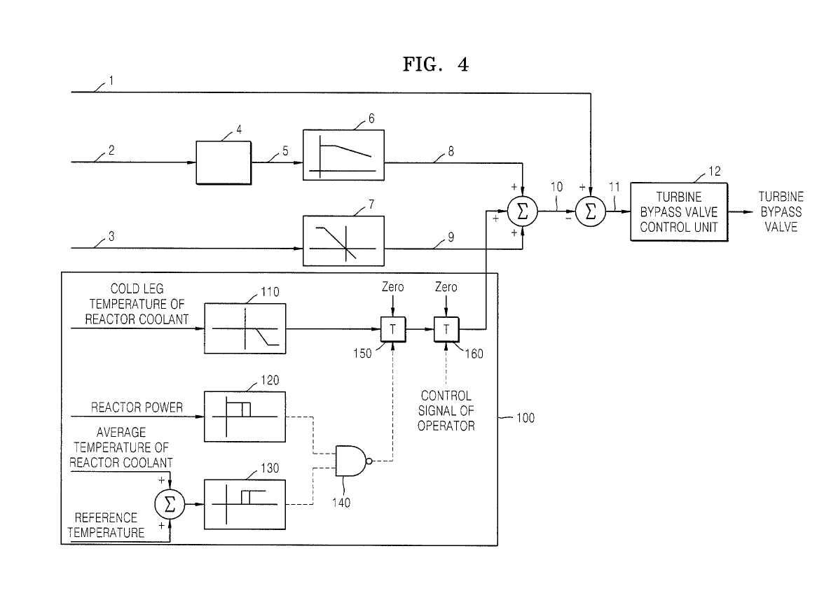

FIG. 4 is a block diagram of an apparatus for automatically controlling a steam bypass control system, according to an embodiment of the present invention. The automatic control apparatus includes the output control apparatus 100 illustrated in FIG. 2, a turbine bypass valve control unit 12, and circuits for summing signals and calculating an error.

In FIG. 4, the pressure setting signal output unit 110, the first logic value output unit 120, the second logic value output unit 130, the NAND gate circuit unit 140, the first output control unit 150, and the second output control unit 160 are described above in relation to FIG. 2, and thus, will not be described in detailed here. Hereinafter, the function of the turbine bypass valve control unit 12 will be mainly described.

A main steam header pressure setting signal 2 according to a steam flow, a pressurizer pressure bias signal 3 according to a pressurizer pressure, and a pressure setting signal output from the pressure setting signal output unit 110 are summed, and thus a summed pressure signal 10 is output. After that, a deviation signal 11 corresponding to a difference between a measured steam header pressure signal 1 and the summed pressure signal 10 is calculated and then is output to the turbine bypass valve control unit 12. Then, the turbine bypass valve control unit 12 controls whether to open or close a turbine bypass valve by using the input deviation signal 11. For example, if a current setpoint of the steam bypass control system is decreased by −40 psi corresponding to the pressure setting signal and then is compared to an actual steam header pressure, the turbine bypass valve control unit 12 may automatically open a turbine bypass valve at a lower pressure.

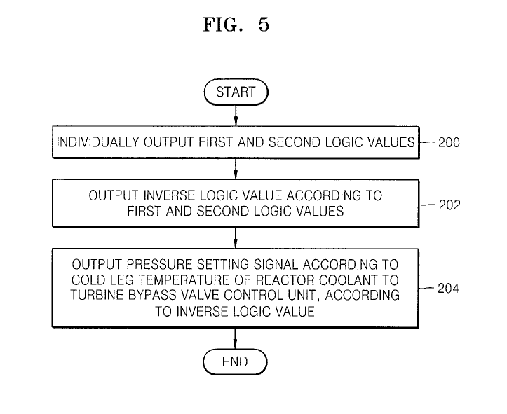

FIG. 5 is a flowchart of a method of controlling an output of a pressure setting signal to automatically control a steam bypass control system, according to an embodiment of the present invention.

A first logic value that is changed according to an increase or decrease in reactor power and a second logic value that is changed according to a temperature difference between an average temperature of a reactor coolant and a reference temperature are individually output (operation 200).

The first logic value is changed and output if the reactor power is increased above a first reference ratio or is decreased below a second reference ratio. If the reactor power is increased (synchronization) above the first reference ratio, the first logic value is changed from “1” to “0” and the changed first logic value of “0” is output. Also, if the reactor power is decreased (de-synchronization) below the second reference ratio, the first logic value is changed from “0” to “1” and the changed first logic value of “1” is output.

The second logic value is changed and output if the temperature difference between the average temperature of the reactor coolant and the reference temperature is increased above a first reference temperature or is decreased below a second reference temperature. If the temperature difference is increased above the first reference temperature, the second logic value is changed from “0” to “1” and the changed second logic value of “1” is output. Also, if the temperature difference is decreased below the second reference temperature, the second logic value is changed from “1” to “0” and the changed second logic value of “0” is output.

After operation 200, an inverse logic value is output according to the first and second logic values (operation 202). A logic calculation result of the inverse logic value according to the first and second logic values is as shown in Table 1.

After operation 202, a pressure setting signal according to a cold leg temperature of the reactor coolant is output to a turbine bypass valve control unit for emitting excess steam of a reactor, according to the inverse logic value (operation 204). The pressure setting signal is output to the turbine bypass valve control unit if the reactor power is less than a certain ratio and if the temperature difference between the average temperature of the reactor coolant and the reference temperature is greater than a certain temperature. For example, the pressure setting signal is output if the inverse logic value of “0” is received. However, a value of “0” instead of the pressure setting signal is output if the inverse logic value of “1” is received. Accordingly, since “1” is output if the temperature difference between the reference temperature that is changed while ramping turbine power (a variable representing the turbine power) and the average temperature of the reactor coolant is increased above a certain temperature, and “1” is output if the reactor power is less than a certain ratio, the pressure setting signal is output to the turbine bypass valve control unit only if the reactor power is less than the certain ratio and the temperature difference is greater than the certain temperature.

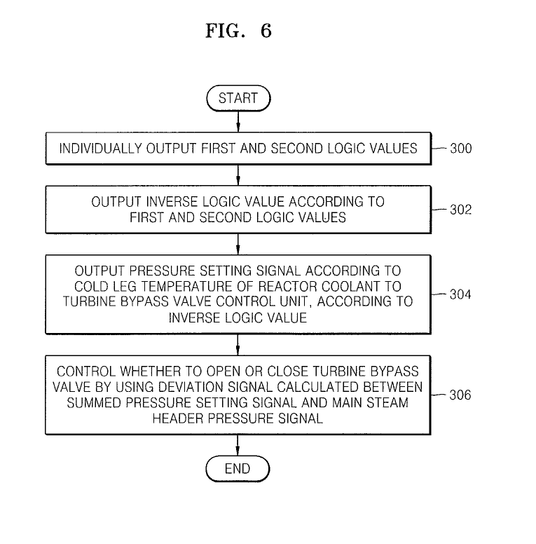

FIG. 6 is a flowchart of a method of automatically controlling a steam bypass control system, according to an embodiment of the present invention.

A first logic value that is changed according to an increase or decrease in reactor power and a second logic value that is changed according to a temperature difference between an average temperature of a reactor coolant and a reference temperature are individually output (operation 300). The first logic value is changed and output if the reactor power is increased above a first reference ratio or is decreased below a second reference ratio. Also, the second logic value is changed and output if the temperature difference between the average temperature of the reactor coolant and the reference temperature is increased above a first reference temperature or is decreased below a second reference temperature.

After operation 300, an inverse logic value is output according to the first and second logic values (operation 302). A logic calculation result of the inverse logic value according to the first and second logic values is as shown in Table 1.

After operation 302, a pressure setting signal according to a cold leg temperature of the reactor coolant is output to a turbine bypass valve control unit for emitting excess steam of a reactor, according to the inverse logic value (operation 304). The pressure setting signal is output to the turbine bypass valve control unit if the reactor power is less than a certain ratio and if the temperature difference between the average temperature of the reactor coolant and the reference temperature is greater than a certain temperature. Accordingly, since “1” is output if the temperature difference between the reference temperature that is changed while ramping turbine power (a variable representing the turbine power) and the average temperature of the reactor coolant is increased above a certain temperature, and “1” is output if the reactor power is less than a certain ratio, the pressure setting signal is output to the turbine bypass valve control unit only if the reactor power is less than the certain ratio and the temperature difference is greater than the certain temperature.

After operation 304, if a steam header pressure setting signal according to a steam flow, a pressurizer pressure bias signal according to a pressurizer pressure, and the pressure setting signal are summed, and a deviation signal between the summed pressure signal and a measured steam header pressure signal is calculated, whether to open or close a turbine bypass valve is controlled by using the calculated deviation signal (operation 306). If a current setpoint of the steam bypass control system is decreased by a value corresponding to the pressure setting signal and then is compared to an actual steam header pressure, the turbine bypass valve control unit automatically opens a turbine bypass valve at a lower pressure.

As such, according to the present invention, since a setpoint of a steam bypass control system is changed by using a cold leg temperature of a reactor coolant as an input variable, the cold leg temperature of the reactor coolant may not be increased. Also, in high-power synchronization and de-synchronization of the steam bypass control system, the cold leg temperature of the reactor coolant may be conveniently controlled in a remote auto mode within an operating limit defined in plant technical specifications without the manual control of an operator. As such, since the cold leg temperature of the reactor coolant is automatically maintained within the operating limit defined in the plant technical specifications during high-power synchronization and de-synchronization, inconvenience of the operator maybe greatly reduced and a quick open mode may be employed to deal with a transient state of a power plant caused when an event such as load rejection occurs while ramping the turbine power for de-synchronization.

The above-described method according to an embodiment of the present invention can also be embodied as computer-readable code/instructions/programs. For example, the method can be implemented in general-use digital computers that execute the code/instructions/programs using a computer-readable recording medium. Examples of the computer-readable recording medium include storage media such as magnetic storage media (e.g., ROM, floppy disks, hard disks, magnetic tapes, etc.) and optical recording media (e.g., CD-ROMs, DVDs, etc.).

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An apparatus for controlling an output of a pressure setting signal to automatically control a steam bypass control system, the apparatus comprising:
a pressure setting signal output unit for outputting a pressure setting signal according to a cold leg temperature of a reactor coolant;
a first logic value output unit for outputting a first logic value that is changed according to reactor power;
a second logic value output unit for outputting a second logic value that is changed according to a temperature difference between an average temperature of the reactor coolant and a reference temperature;
a NAND gate circuit unit for outputting an inverse logic value according to the first and second logic values output from the first and second logic value output units; and
a first output control unit for controlling whether to output the pressure setting signal to a turbine bypass valve control unit for emitting excess steam of a reactor, according to the inverse logic value of the NAND gate circuit unit.

2. The apparatus of claim 1, wherein the pressure setting signal output unit outputs the pressure setting signal for decreasing a pressure setpoint by a certain value if the cold leg temperature of the reactor coolant is increased above a certain temperature.

3. The apparatus of claim 1, wherein the first logic value output unit changes and outputs the first logic value if the reactor power is increased above a first reference ratio or is decreased below a second reference ratio.

4. The apparatus of claim 3, wherein a deadband in which the first logic value is not changed exists between the first and second reference ratios.

5. The apparatus of claim 1, wherein the second logic value output unit changes and outputs the second logic value if the temperature difference between the average temperature of the reactor coolant and the reference temperature is increased above a first reference temperature or is decreased below a second reference temperature.

6. The apparatus of claim 5, wherein a deadband in which the second logic value is not changed exists between the first and second reference temperatures.

7. The apparatus of claim 1, wherein the first output control unit controls to output the pressure setting signal to the turbine bypass valve control unit if the reactor power is less than a certain ratio and the temperature difference between the average temperature of the reactor coolant and the reference temperature is greater than a certain temperature.

8. The apparatus of claim 1, further comprising a second output control unit for controlling whether to output the pressure setting signal to the turbine bypass valve control unit, according to a control signal of an operator.

9. An apparatus for automatically controlling a steam bypass control system, the apparatus comprising:
a pressure setting signal output unit for outputting a pressure setting signal according to a cold leg temperature of a reactor coolant;
a first logic value output unit for outputting a first logic value that is changed according to reactor power;
a second logic value output unit for outputting a second logic value that is changed according to a temperature difference between an average temperature of the reactor coolant and a reference temperature;
a NAND gate circuit unit for outputting an inverse logic value according to the first and second logic values output from the first and second logic value output units;
a first output control unit for controlling whether to output the pressure setting signal according to the inverse logic value of the NAND gate circuit unit; and
a turbine bypass valve control unit for controlling whether to open or close a turbine bypass valve by using a deviation signal calculated between a measured main steam header pressure signal and a summed pressure signal obtained by summing a main steam header pressure setting signal according to a steam flow and a pressurizer pressure bias signal according to a pressurizer pressure with the pressure setting signal.

10. A method of controlling an output of a pressure setting signal to automatically control a steam bypass control system, the method comprising:
individually outputting a first logic value that is changed according to an increase or decrease in reactor power and a second logic value that is changed according to a temperature difference between an average temperature of a reactor coolant and a reference temperature;
outputting an inverse logic value according to the first and second logic values; and
outputting a pressure setting signal according to a cold leg temperature of the reactor coolant to a turbine bypass valve control unit for emitting excess steam of a reactor, according to the inverse logic value.

11. The method of claim 10, wherein the outputting of the first logic value comprises changing and outputting the first logic value if the reactor power is increased above a first reference ratio or is decreased below a second reference ratio.

12. The method of claim 10, wherein the outputting of the second logic value comprises changing and outputting the second logic value if the temperature difference between the average temperature of the reactor coolant and the reference temperature is increased above a first reference temperature or is decreased below a second reference temperature.

13. The method of claim 10, wherein the outputting of the pressure setting signal to the turbine bypass valve control unit comprises outputting the pressure setting signal to the turbine bypass valve control unit if the reactor power is less than a certain ratio and if the temperature difference between the average temperature of the reactor coolant and the reference temperature is greater than a certain temperature.

14. A method of automatically controlling a steam bypass control system, the method comprising:
individually outputting a first logic value that is changed according to an increase or decrease in reactor power and a second logic value that is changed according to a temperature difference between an average temperature of a reactor coolant and a reference temperature;
outputting an inverse logic value according to the first and second logic values;
outputting a pressure setting signal according to a cold leg temperature of the reactor coolant to a turbine bypass valve control unit for emitting excess steam from a reactor, according to the inverse logic value; and
controlling whether to open or close a turbine bypass valve by using a deviation signal calculated between a measured main steam header pressure signal and a summed pressure signal obtained by summing a main steam header pressure setting signal according to a steam flow, a pressurizer pressure bias signal according to a pressurizer pressure, and the pressure setting signal.
